(19) United States
(12) Patent Application Publication
(10) Pub. No.: US 2005/0286952 A1
(43) Pub. Date: Dec. 29, 2005

(54) NUSPEL orthography and keyboard

(76) Inventor: L. William Kirby, Albuquerque, NM (US)

Correspondence Address: L. William Kirby, 11204 Country Club NE, Albuquerque, NM, 87111, US

(21) Appl. No.: 10/873,439

(22) Filed: Jun. 23, 2004

(51) Int. Cl. B41J 5/08

(52) U.S. Cl. 400/472

(57) ABSTRACT

An alphabet for English that consistently matches sounds with letters and letters with sounds; thereby, creating a written English language that is easier to learn with regard to its spelling, reading and writing. As a logical extension, there is a keyboard that accommodates the letters used by this alphabet.

### BACKGROUND

1. Field of Invention

This invention relates to the development of a phonetic alphabet for English and the design of a keyboard for this alphabet.

2. Prior Art

The history of the English language is rich. It has been influenced by many foreign languages, economic and educational class distinctions, the discovery of new worlds, the creation of new inventions, and the mere passage of time. Spoken and written English have evolved but not always in a parallel fashion. If spoken and written English were compared to two railroad rails, we would observe that the rail representing spoken English twists and turns and changes rapidly as it adapts to changes in the linguistic landscape. However, the rail representing written English changes ever so slowly as it is mired in tradition, foreign spellings, silent letters, and archaic, un-phonetic spellings. The result of the two non-parallel rails of spoken and written English is a virtual linguistic train wreck.

Recognition of this problem with the English language is not new. Many attempts have been made to bring written and spoken English together. Proponents include such diverse personalities as Samuel Clements, George Bernard Shaw and President Theodore Roosevelt. Many names have been given to these attempts; including, Phonic Shorthand, Phonography, RITE Spell, Truespel, Unifon, Shavian, RES positional spelling, and Simplified Spelling. However, no alternative system for spelling English has won acceptance.

As a result, countless additional hours are spent learning to read, write and spell a language which is written in a form that is inconsistent with the language's pronunciation. The learning of written English by native speakers is unnecessarily laborious and complex, but the task is incrementally difficult for the millions who are learning English as a second or third language. In commerce, government, entertainment, education, and in all other areas of human endeavor, English is becoming the pervasive language of communication. It is likely that we have reached a point at which more people communicate in English as a second language than communicate in English as native speakers. English, in this era, is the primary means for communication among different peoples. Is it important that we communicate well and accurately? Is it important that we understand each other? If this communication and understanding are important, then it is imperative that we make English as learnable as possible.

### DETAILS OF PRIOR ART

What is the current state-of-the-art spelling of English? A detailing of just some of the inconsistencies in current English spelling is listed below:
1. English has 26 letters but 40 sounds. (The exact number of sounds depends on the dialect which is analyzed.)
2. There are 6 vowels but 16 vowel or diphthong sounds. (Here again, there are dialectic differences.)
3. There are 26 letters but 45 configurations of those letters in just one font.
   a. AaBbCDdEeFfGgHhIiJjKkLlMmNnOPpQqRrSTtUuVWXYyZ

4. The same vowel is pronounced in different ways or completely silent.

| | | | | | | | |
|---|---|---|---|---|---|---|---|
| a. A, a | as in able | absent | about | all | road | ward | |
| b. E, e | as in ego | edit | agent | made | beau | | |
| c. I, i | as in ice | fit | pencil | suit | eight | bunion | |
| d. O, o | as in go | dog | for | atom | who | woman | women |
| e. U, u | as in ruin | but | fur | circus | butte | | |
| f. Y, y | as in by | happy | nymph | | | | |

5. The same vowel sound is spelled in different ways. The “long U” sound is spelled 23 different ways as indicated below:

| | |
|---|---|
| a. | to |
| b. | too |
| c. | two |
| d. | blue |
| e. | flew |
| f. | troupe |
| g. | suit |
| h. | flu |
| i. | canoe |
| j. | through |
| k. | rule |
| l. | lieu |
| m. | loose |
| n. | lose |
| o. | pooh |
| p. | coup |
| q. | bruise |
| r. | mousse |
| s. | silhouette |
| t. | buoy |
| u. | deuce |
| v. | sleuth |
| w. | rendezvous |

6. Consonants and consonant blends represent different sounds or no sound at all.

| | | | | | | | | |
|---|---|---|---|---|---|---|---|---|
| a. B, b | as in | bed | | | comb | | | |
| b. C, c | as in | car | | | city | | | scent |
| c. Ch, ch | as in | church | | | Chicago | | ache | yacht |
| d. D, d | as in | dog | | | judge | | | cordial |
| e. F, f | as in | for | | | of | | | |
| f. G, g | as in | go | gem | rough | gnarl | espionage | | among |
| g. H, h | as in | he | | | ought | | | aphid |
| h. K, k | as in | kit | | | knit | | | |
| i. L, l | as in | lad | | | calm | | | |
| j. M, m | as in | man | | | comptroller | | | |
| k. N, n | as in | nut | | | column | | | |
| l. P, p | as in | pig | | | psyche | | | phone |
| m. R, r | as in | red | | | February | | | |
| n. S, s | as in | sad | has | | Asia | | conscience | |
| o. T, t | as in | to | often | | nation | | nature | |
| p. Th, th | as in | this | | | thank | | | |
| q. W, w | as in | win | | | wrong | | | |
| r. X, x | as in | exit | | | xylophone | | | exalt |
| s. Y, y | as in | yes | | | by (a vowel) | | | say |

In summary, given that
1. many English letters have two distinct configurations (capital and small case),
2. the same letter is pronounced a number of different ways, and
3. the same pronounced sound is frequently represented by different letters;
   it is clear that;
1. a new system for spelling English could be developed that is more consistent with the pronunciation of English, and
2. the adoption of such a system would make the learning of spelling, reading and writing English much easier.

### OBJECTS AND ADVANTAGES

NUSPeL Orthography is a system of phonetic spelling that makes spoken and written English into one consistent language that is easier to learn. It uses the following twenty guidelines:
1. The number of letter configurations is reduced from 45 to 37. One does not need to learn that D and d are the same letter with the same sound. Likewise, with A and a, B and b, E and e, F and f, G and g, etc.
2. The large case (capital letters) and the small case letters are identical except for size. Large case letters are A,B,C,D,E, etc. Small case letters are A,B,C,D,E etc.
3. NUSPeL has 18 of the 19 consonants looking just like they look now. B,D,F,G,H,J,K,L,M,N,P,R,S,T,V,W,Y, and Z.
4. The one new consonant is “ [symbol] ” as in wing and sing. This letter only exists in the small case.
5. There are no double consonants unless both consonants are heard. Examples: bookkeeper (Yes, a double consonant.) bill (No.)
6. There are five consonant blends; three of them are identical to some of their current uses. “CH” as church and chip, not as in Chicago and ache. “SH”, as is shed and dish. “TH” as in thin and bath not as in this and that.
7. The two new consonant blends are “TH” and “ZH”. “TH” as mentioned above in words such as “this” and “that”. “ZH” is the blend in measure and azure.
8. There are 14 vowel sounds and two diphthongs; therefore, NUSPeL has 14 vowel letters and two diphthong letters.
9. The “long” vowel sounds are represented by the “capital” cases of the five traditional vowels. “A” as in ape. “E” as in eel. “I” as in ice. “O” as in oh. “U” as in ooze.
10. The “short” vowel sounds are represented by small cases of four of the traditional vowels. “a” as in am. “e” as in elm. “i” as in it. “U” as in up.
11. The vowel sound in autumn, all, and art is represented by the letter “ [symbol] ”, which many native speakers learned in elementary school handwriting
12. The vowel sound in book and look and shook is represented by the letter “ø”. This letter exists only in the small case.
13. The vowel sound in oar and bore is represented by the letter “\dot{O}”. This letter is always followed by the letter “R”.
14. The vowel sound in hurt and fur is represented by the letter “\dot{u}”. This letter is always followed by the letter “R”.
15. The vowel sound in ago, agent, pencil, atom and circus is represented by the letter “u”. This vowel sound is particularly pervasive. Its sound is quite similar to the “u”, but less vocalized and exists only in unaccented syllables.
16. The diphthong vowel sound in owl and about is represented by the letter “ [symbol] ”.
17. The diphthong vowel sound in boy and oink is represented by the letter “ [symbol] ”.
18. All syllables contain one vowel or diphthong, but only one.
19. There are no apostrophes used to show possession or word contractions.
   Possession: No more “John's” or “Jill's” or “man's” or “women's”.
   Contractions: No more “it's” or “we're” or “they're” or “can't”.
20. The other rules of punctuation remain the same as they are now.

Accordingly, the NUSPeL alphabet is presented as:
1. a simplified alphabet with
   a. thirty-seven distinct letters, with
   b. upper and lower case letters having identical configurations but different only in their size, with
   c. twenty-eight letters selected from the current alphabet, and nine modified or new letter configurations; AA,aa, d(1 J aJ, BB, CC, DD, EE,ee, FF, GG, HH, Ii, ii, JJ, KK, LL, MM, NN, N, Oo, Oo, (E im Pp, RR, Ss, TT, TT, Uu, Uu, tt, Uu, Vv, Ww, YY, Zz.
2. a phonetic alphabet with
   a. each letter representing one sound, and
   b. each sound represented by one letter or a blend of letters, with

c. nineteen consonants;

| [symbol] | | Traditional | | Traditional |
|---|---|---|---|---|
| Consonant | | Example #1 | | Example #2 |
| 1. [symbol] | as in | bed | and | tub |
| 2. [symbol] | as in | dog | and | bid |
| 3. [symbol] | as in | fall | and | if |
| 4. [symbol] | as in | go | and | tag |
| 5. [symbol] | as in | hat | and | ahead |
| 6. [symbol] | as in | jab | and | badge |
| 7. [symbol] | as in | cat | and | tack |
| 8. [symbol] | as in | lad | and | tall |
| 9. [symbol] | as in | mat | and | am |
| 10. [symbol] | as in | no | and | on |
| 11. [symbol] | as in | | | ring |
| 12. [symbol] | as in | pet | and | tip |
| 13. [symbol] | as in | rag | and | tar |
| 14. [symbol] | as in | sit | and | ace |
| 15. [symbol] | as in | tin | and | cut |
| 16. [symbol] | as in | vote | and | of |
| 17. [symbol] | as in | wise | and | away |
| 18. [symbol] | as in | yell | and | canyon |
| 19. [symbol] | as in | zoo | and | as |

d. and five consonant blends;

| [symbol] | | Traditional | | Traditional |
|---|---|---|---|---|
| Blend | | Example #1 | | Example #2 |
| 1. [symbol] | as in | chin | and | each |
| 2. [symbol] | as in | shed | and | dish |
| 3. [symbol] | as in | thin | and | bath |
| 4. [symbol] | as in | this | and | bathe |
| 5. [symbol] | as in | | | azure |

e. with fourteen vowels;

| [symbol] | | Traditional | | Traditional |
|---|---|---|---|---|
| Vowel | | Example #1 | | Example #2 |
| 1. [symbol] | as in | ape | and | bait |
| 2. [symbol] | as in | am | and | bat |
| 3. [symbol] | as in | odd | and | bought |
| 4. [symbol] | as in | eel | and | beat |
| 5. [symbol] | as in | elm | and | bet |
| 6. [symbol] | as in | ice | and | bite |
| 7. [symbol] | as in | is | and | bit |
| 8. [symbol] | as in | ode | and | boat |
| 9. ø | as in | | | book |
| 10. [symbol] | as in | oar | and | bore |
| 11. [symbol] | as in | ooze | and | boot |
| 12. [symbol] | as in | up | and | but |
| 13. [symbol] | as in | again | and | bazaar |
| 14. [symbol] | as in | earth | and | Bert |

g. and two diphthongs;

| | | | | |
|---|---|---|---|---|
| 1. [symbol] | as in | owl | and | about |
| 2. [symbol] | as in | oink | and | boy |

### SUMMARY

Accordingly, one can observe the following:
NUSPeL Orthography is a new system for spelling English phonetically;
it is a system that consistently uses a combination of existing letters and new letters to represent the spoken sounds in English;
it provides a spelling system that employs primarily existing letters and minimizes “foreignness”;
it is a system that is easily accommodated by a standard keyboard with adapted fonts;
it is a system that is amenable to word-processing on computers.

### DETAILED DESCRIPTION OF NUSPeL KEYBOARD

The development of NUSPeL Orthography logically requires a keyboard that would enable the word processing of English in NUSPeL. Accordingly, below is the design for the NUSPEL keyboard.

[image]

### A SAMPLE OF NUSPeL ORTHOGRAPHY

### A SaMPUL uv NUSPeL \dot{O}RTHOGRUFE

### A Sample of NUSPeL Orthography

THeRR TU DiSTiTi [symbol] V KUMPONUNTS TU THiS PRUPOZuL:

There are two distinctive components to this proposal:
(1) THU DiVeLUPMUNT UV A FUNeTiKLE KUNSiSTUNT, YUZ\dot{U}R-FReNDLE
(1) The development of a phonetically consistent, user-friendly
aLFUBeT THaT WiL SiMPLUFI THU REDi [symbol] aND RITi [symbol] UV \dot{I}GLiSH. THiS SiSTUM
alphabet that will simplify the reading and writing of English. This system
iZ NAMD NUSPeL \dot{O}RTHOGRUFE.
is named NUSPeL Orthography.
   (2) THU DiVeLUPMUNT UV A KUMPYUT\dot{U}R KEB\dot{O}RD THaT WiL iFiSHUNTLE
   (2) The development of a computer keyboard that will efficiently
YUZ THiS aLFUBeT iN W\dot{U}RDPROSeSi [symbol] GN A KUMPYUT\dot{U}R
use this alphabet in wordprocessing on a computer.

### CONCLUSION, RAMIFICATIONS, AND SCOPE

Accordingly, one can observe the following:
NUSPeL Orthography is a new system for spelling English phonetically;
it is a system that consistently uses a combination of existing letters and new letters to represent the spoken sounds in English;
it provides a spelling system that employs primarily existing letters and minimizes “foreignness”;
it is a spelling system that is easily accommodated by a standard keyboard with adapted fonts;
it is a spelling system that is amenable to word-processing on computers;
it is a spelling system that is consistent with the pronunciation of English;
it is a spelling system whose consistency would make learning to read and write English easier than it is using the current spelling system.

Although the description above contains many specifications, these should not be construed as limiting the scope of the invention but as merely providing an illustration. For example, the size and the design of the font can change; the exact location of the letters on the keyboard can vary, etc. Thus the scope of the invention should be determined by the appended claims and their legal equivalents, rather than by the illustrations given.

1. the development of a modified alphabet for English that is phonetic, comprising:
a. letter configurations that consistently represent one sound, and
b. each sound has only one written configuration, and
c. forty sounds represented in written form by:
i. fourteen vowels, and
ii. two diphthongs, and
iii. nineteen consonants,
iv. and five diphthongs, and
d. large case and small case letters having identical configurations except for size, and
e. the use of twenty-eight existing letter configurations, and
f. the use of nine new letter configurations, thereby
g. providing spoken English and written English as one language instead of two, and
h. providing English as a substantially easier language to learn for those learning it as a second language, and
i. providing English as a substantially easier language to learn how to read, write and spell for native speakers.

2. the design of a keyboard for aforementioned phonetic alphabet, comprising:
a. location for letters, large and small case, and
b. location for numbers, and
c. location for punctuation marks and symbols, and
d. a positioning of letters, numbers, punctuation marks and symbols to accommodate efficient keyboarding, and
e. flexibility to use different font sizes and styles, thereby,
f. providing the means to communicate in writing with aforementioned phonetic alphabet.
